(19) United States
(12) Patent Application Publication
(10) Pub. No.: US 2005/0047889 A1
(43) Pub. Date: Mar. 3, 2005

(54) Fixing member for securing stacked plates

(75) Inventor: Hong-Chi Lee, Taipei City (TW)

Correspondence Address: BACON & THOMAS, PLLC, 625 SLATERS LANE, FOURTH FLOOR, ALEXANDRIA, VA, 22314, US

(73) Assignee: TECHMECH TECHNOLOGIES CORP., Hsichih City (TW)

(21) Appl. No.: 10/646,794

(22) Filed: Aug. 25, 2003

(51) Int. Cl. F16B 21/18

(52) U.S. Cl. 411/352

(57) ABSTRACT

A fixing member for securing stacked plates is disclosed. According to a major aspect of the present invention, a internal threaded portion is formed within the receiving space of the screw element of the fixing member, and the top flange of the securing set has a corresponding external threaded portion for engaging with the internal threaded portion of the screw element. The purpose such an arrangement is for securing the screw element with securing set at any time and also for separating the screw element from the securing set for replacement thereof with a variety of screw elements, for example, the screw element having an oval head, a Phillips head, a star or hex type as desired.

### BACKGROUND OF THE INVENTION

1. Field of the Invention

The present invention generally relates to a fixing member for securing stacked plates, and more particularly relates to a fixing member having a threaded portion securing an interchangeable screw element with a positioning set so that every assembly part of the fixing member can be separated from each other allowing replacements with a variety of replacement elements that can facilitate its usage using hand and tools for easy assembly as desired and can be applied in wide-range of appliances.

2. Description of the Related Art

With rapid advances in the industry field, the process or manufacture of many products requires a variety of machineries, such as lathe, miller, driller, presser and the like. However, the motor driven device or frequency adjusting device installed in the above mentioned machines are designed to have a detachable plate on the shell of the motor driven device or frequency adjusting device for providing the convenience of repair or maintenance, for example, for adjusting the operation frequency while the machine is operating. The conventional detachable plate is typically fixed in the machines using a plurality of screws. However there is one problem from using such an arrangement, in that, sometimes the user may misplace one or more screws, one or more screws may fall in spaces where the user may not get access to, while detaching the plate. In order to overcome these problems, some have proposed to use a positioning element comprising a screw head, a shank and a positioning set that can be assembled for fixing the plate. To fix the positioning set of the fixing element into a bore of the plate, the shank is engaged into another plate for securing. Because the positioning set of the fixing element is still positioned within the bore of the plate even after detaching the plate, the positioning member will not be misplaced or dropped. Nevertheless, the screw head of this conventional positioning mechanism is made of a metal, after engaging the shank into the receiving space of the screw head, a machine is needed to press for ensuring the shank within the receiving space of the screw head.

Furthermore, the conventional positioning member C includes a buckling the screw head A within the positioning set B (referring to FIGS. 11 and 12) to substantially inlay the shank A1 into the screw head A and the screw head A is buckled into the positioning set B. Further the inner hook A2 positioned at the lower portion of the screw head A is buckled to the protruded flange B1 positioned at the upper portion of the positioning set B, so that the screw head A buckle of the positioning set B. The buckle B2 positioned at the lower side of positioning set B of the positioning member C is buckled to the positioning plate D. The shank A1 positioned within the screw head A is driven downwards into the securing plate D1 using a hand tool for fixing the positioning plate D with the securing plate D1. But the screw head A and the positioning set B of the positioning member C are hard elements, which are made of metallic material, once the inner hook A2 of the screw head A buckles to the protruded flange B1 of the positioning set B, it will be difficult to separate these elements. Accordingly, the user will be unable to replace any of the damaged elements of the positioning member C, thus the usage thereof is limited.

Additionally, the hand tool used for engaging the shank A1 within the screw head A depends on the specification of the socket of the shank A1, for example, an oval head, a Phillps head, a star or hex type and so on. Therefore for maintaining and/or replacing the parts of the positioning member C, the user must have specific tools for driving the shank A1 for detaching the securing plate D1. Only the specialized technician or in certain occasion, a variety of such specific tools are required. Generally, small factories or workshops may not posses such specific tools. Without the specific tools, the shank A1 cannot be tightened or loosened, thus limiting the use of the positioning member C.

Furthermore, hand or specific tools are needed to loosen the above conventional positioning member in order to separate the securing plate and the positioning plate, but the screw head and the positioning set of the positioning member are irreversibly buckled to each other and therefore cannot be separated or replaced. For removing the screw head, the user must use the specific tool to fit the specification of the shank of the screw head. In the other words, if the user doesn't have or can't find this specific tool, then the disassembly of the positioning member cannot be implemented. Therefore, it is highly desirable to improve the design of the conventional positioning member to resolve the foresaid problems.

### SUMMARY OF THE INVENTION

Accordingly, in the view of the foregoing, the present inventor makes a detailed study of related art to evaluate and consider, and uses years of accumulated experience in this field, and through several experiments, to create a new positioning member of the present invention.

According to a major aspect of the present invention, a threaded portion is formed within the receiving space of the screw element of the fixing member, and the top flange of the securing set has a corresponding threaded portion for engaging with the threaded portion of the screw element. The purpose such an arrangement is for securing the screw element with securing set at any time and also for separating the screw element from the securing set for replacement thereof with a variety of screw elements, for example, the screw element having an oval head, a Phillps head, a star or hex type as desired.

According to another aspect of the present invention, the positioning element of the screw element comprises a top lid, which is inlayed within the inner sidewall of the knob, to avoid the knob from idly spinning as the positioning element spins.

### BRIEF DESCRIPTION OF THE DRAWINGS

For a more complete understanding of the present invention, reference will now be made to the following detailed description of preferred embodiments taken in conjunction with the accompanying drawings, in which:

FIG. 1 is the elevational view of the fixing member of the present invention;

FIG. 2 is an exploded view of the fixing member of the present invention;

FIG. 3 is a sectional side view of the fixing member of the present invention;

FIG. 4 is a sectional view of the fixing member of the present invention showing the engagement position of the screw element and the securing set;

FIG. 5 is the sectional view of the fixing member of the present invention showing the disengagement position of the screw element and the securing set;

FIG. 6 is a prospective view of a variety of types of socket portion of the knob of the present invention;

FIG. 7 is a sectional view before securing the fixing member of the present invention with a plate;

FIG. 8 is a sectional view while securing the fixing member of the present invention to a plate;

FIG. 9 is a sectional view after securing the fixing member of the present invention to a plate;

FIG. 10 is a sectional side view of a fixing member according to another preferred embodiment of the present invention;

FIG. 11 is a sectional side view showing before securing the positioning member of the conventional art; and

FIG. 12 is a sectional side view showing after securing the positioning member of the conventional art.

### DESCRIPTION OF THE PREFERRED EMBODIMENTS

Reference will be made in detail to the preferred embodiments of the invention, examples of which are illustrated in the accompanying drawings. Wherever possible, the same reference numbers are used in the drawings and the description to refer to the same or like parts.

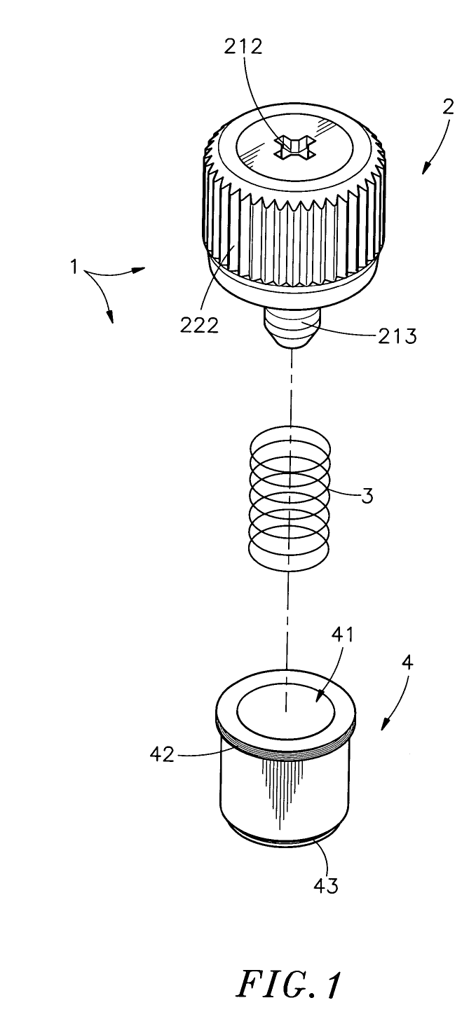

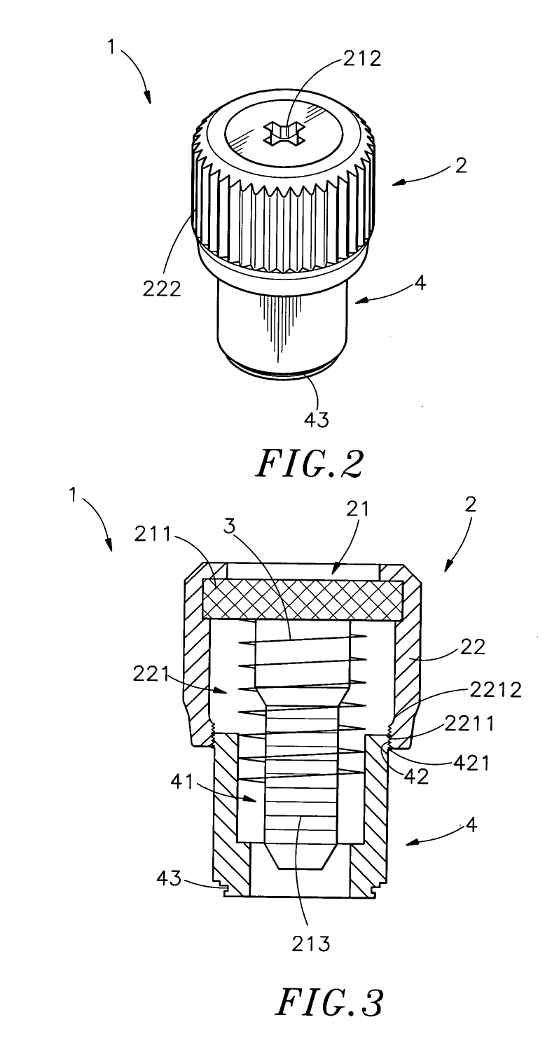

Referring to FIGS. 1, 2 and 3, show the elevational view, the exploded view and the sectional side view of the fixing member of the present invention. The fixing member 1 of the present invention comprises a screw element 2, a resilient element 3 and a securing set 4.

The screw element 2 comprises a positioning element 21 having a top lid 211 with a socket portion 212 and a shank 213 at a lower portion thereof. A knob 22 engagingly surrounds the positioning element 21. The knob 22 has a receiving space 221. An internal threaded portion 2211 is positioned at a bottom portion of the inner sidewall of the receiving space 221, and a supporting portion 2212 is positioned at an upper side of internal threaded portion 2211. Furthermore, the outer part of the knob 22 is configured into a grip portion 222.

The resilient element 3 surrounds the outer flange of the shank 213 of the screw element 2.

The securing set 4 comprises a through hole 41 and an external threaded portion 42, which correspond to the internal threaded portion 2211 of the screw element 2, is disposed at the outer flange positioned at the rim portion of the securing set 4. A supporting portion 421 is formed at the lower side of the external threaded portion 42, and a plurality of the buckling grooves 43 is formed at the bottom side of the securing set 4.

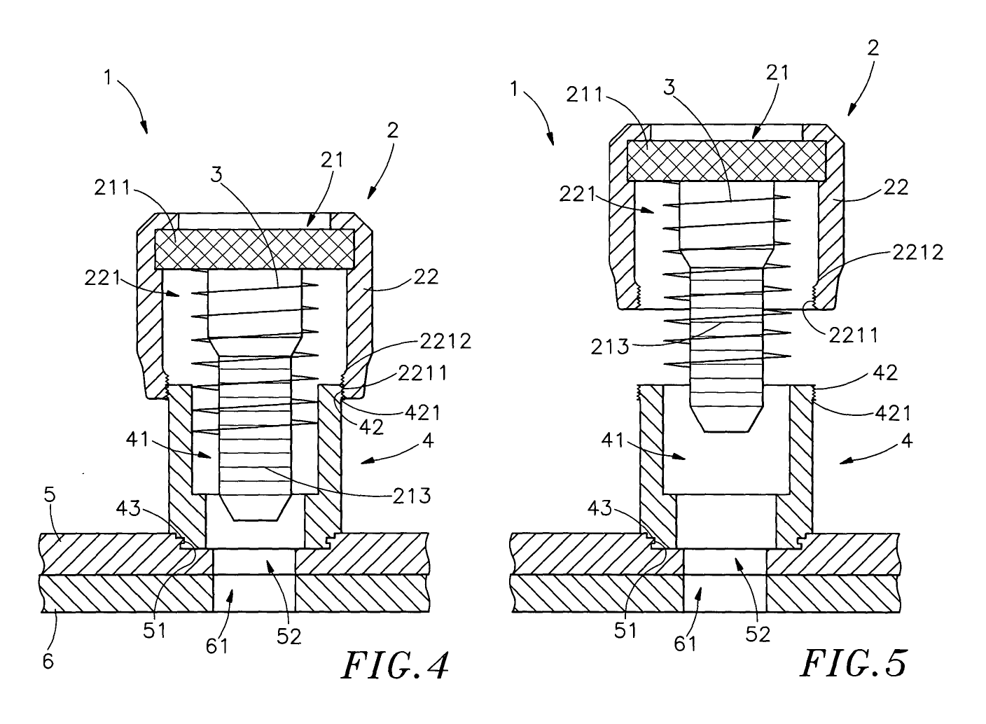

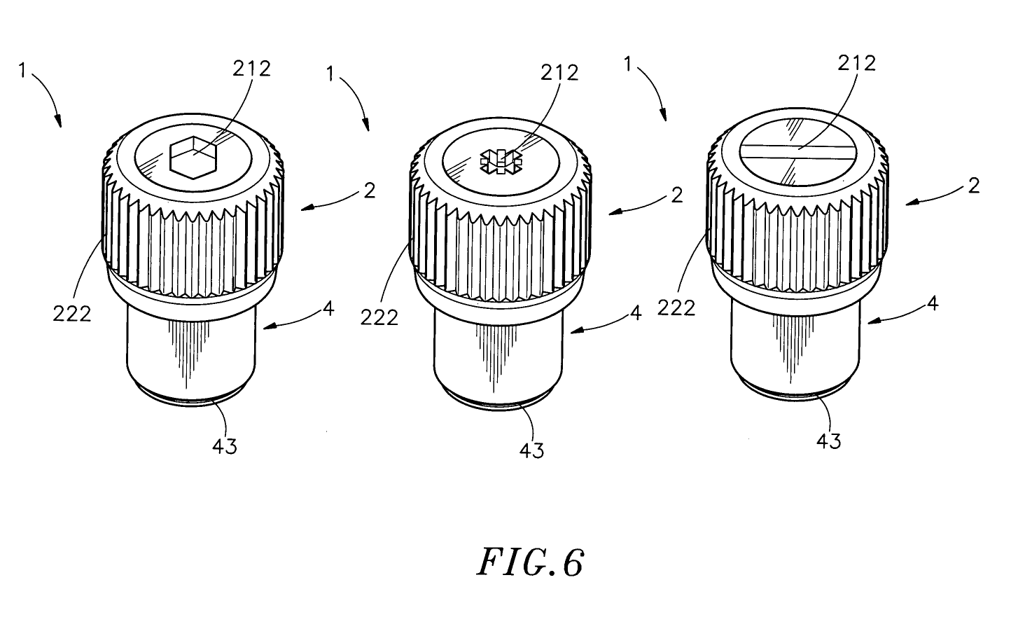

Referring to FIGS. 4, 5 and 6, a sectional view of the engagement position of the screw element and the securing set, an sectional view of the disengagement position of the screw element and the securing set, and a prospective view of a variety of socket portion of the knob, according to a preferred embodiment of the present invention is shown. The assembling of the fixing member 1 will now be described referring to the FIGS. 4, 5 and 6. First, the plurality of buckling grooves 43 at the lower side of the securing set 4 is inlayed into the through hole 51 of a first plate 5. Next, the shank 213 of the screw element 2 is positioned into the receiving space 221 so that the external threaded portion 42 of the securing set 4 is aligned with the internal threaded portion 2211 of the screw element 2, and then the external threaded portion 42 is engaged with the internal threaded portion 2211. For doing so, the user holds the grip portion 222 on the outer part of the knob 22 of the screw element 2 with the aid of fingers and the shank 213 of the screw element 2 is inserted into the receiving space 221 so that the external threaded portion 42 of the securing set 4 is aligned with the internal threaded portion 2211 of the screw element 2, and then the external threaded portion 42 is engaged with the internal threaded portion 2211 by rotating the knob 22 to engage the external threaded portion 42 with the internal threaded portion 2211 until the knob 22 of the screw element 2 cannot be rotated any further. Next, a suitable tool is used to fit into the socket portion 212 of the screw element 2 to tighten further to substantially fasten the screw element 2 into the first plate 5 and the second plate 6. In order to remove the knob 22 from the securing set 4, a suitable tool is fitted into the socket portion 212 of the screw element 2 and the screw element 2 is loosened from the second plate 6 by rotating the screw element 2. Once the screw element 2 is loosened, the user can use hand to hold the grip portion 222 on the outer part of the knob 22 of the screw element 2 to remove the screw element 2 out of the second plate 6 and the first plate 5. To replace the knob 22 of the screw element 2 having a different specification, the knob 22 of the screw element 2 is further rotated in the counter-clock direction until the internal threaded portion 2211 of the knob 22 is completely disengaged from the corresponding external threaded portion 42 of the securing set 4, and then after the replacement, the fixing member 1 can be assembled by following the steps described above. The socket portion 212 of the knob 22 can be of various specifications, for example, the oval head, Phillips head, crossed socket, hex socket and so on. Tools for fitting the specification of the socket portion 212 are easily available so that the usage of the fixing member of the present invention can be more conveniently used compared to the conventional positioning member described above.

When the fixing member 1 is located in a smaller space, such that the user does not have enough space for using the tools, the user can use hand to hold the grip portion 222 on the outer part of the knob 22 to rotate the screw element 2 in order to remove the screw element 2 from the securing set 4. To replace the screw element 2 with another screw element 2, the steps described above can be followed. Thus the fixing member 1 of the present invention can be easily assembled for fixing the detachable stacked plates or easily disassembled for replacements by using either tools or hand.

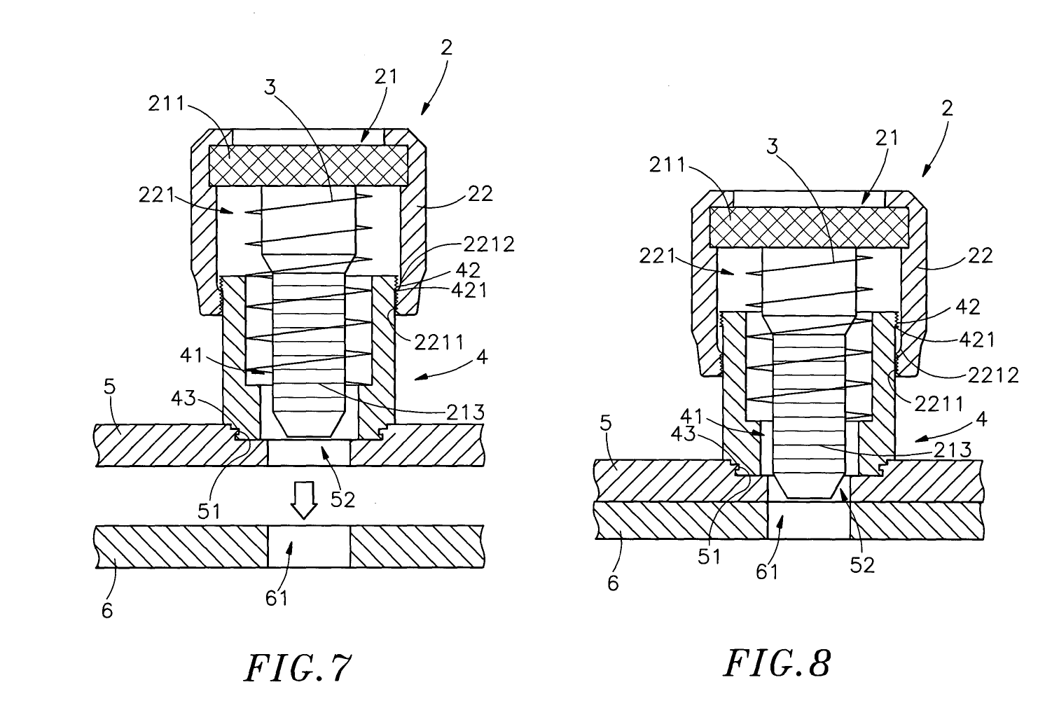

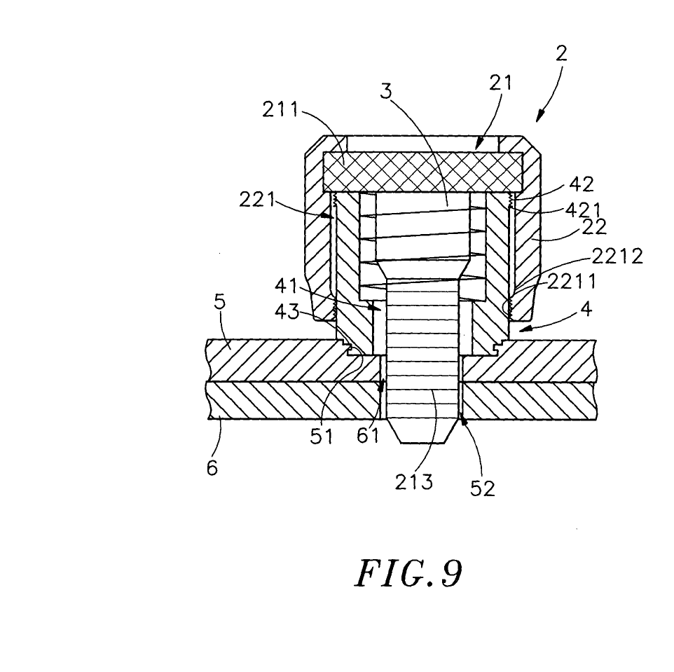

Referring to FIGS. 7, 8 and 9, show a sectional view before securing the fixing member of the present invention with a plate, a sectional view showing while securing the fixing member of the present invention to a plate and a sectional view after securing the fixing member of the present invention to a plate. The securing of the fixing member 1 to the first plate 5 and the second plate 6 will be described referring to FIGS. 7, 8 and 9 as follows. The fixing member 1 of the present invention is buckled and fixed to the first plate 5 such that the buckling groove 43 at the lower side of the securing set 4 is inlayed into the through hole 51 of the first plate 5. Next, by holding the grip portion 222 on the outer part of the knob 22 of the screw element 2 using hand, the screw element 2 is rotated to drive the shank 213 to thread into the first threaded bore 52 of the first plate 5. The screw element 2 is continuously rotated to thread the shank 213 further into the second threaded bore 61 of the second plate 6. Next, a suitable tool is used to fit into the socket portion 212 of the screw element 2 to substantially fasten the shank 213 of the screw element 2 into the first threaded bore 52 and the second threaded bore 61 for fastening to the first plate 5 and the second plate 6 together.

Meanwhile, as the shank 213 is fastened into the first plate 5 and the second plate 6, the knob 22 of the screw element 2 covers around the outer part of the securing set 4. Furthermore, the resilient element 3 positioned within the screw element 2 will be compressed between the screw element 2 and the securing set 4.

For detaching the first plate 5 and the second plate 6, the user may use a suitable tool to fit into the socket portion 212 of the screw element 2 to lossen the screw element 2 out of the second threaded bore 61 of the second plate 6, and then a hand may be used to further loosen by unthreading the shank 213 of the screw element 2 out of the first threaded bore 52 of the first plate 5 to separate the first plate 5 and the second plate 6. The supporting portion 2212 of the knob 22 of the screw element 2 is supported on the supporting portion 421 of the securing set 4 to hold the screw element 2 on the securing set 4.

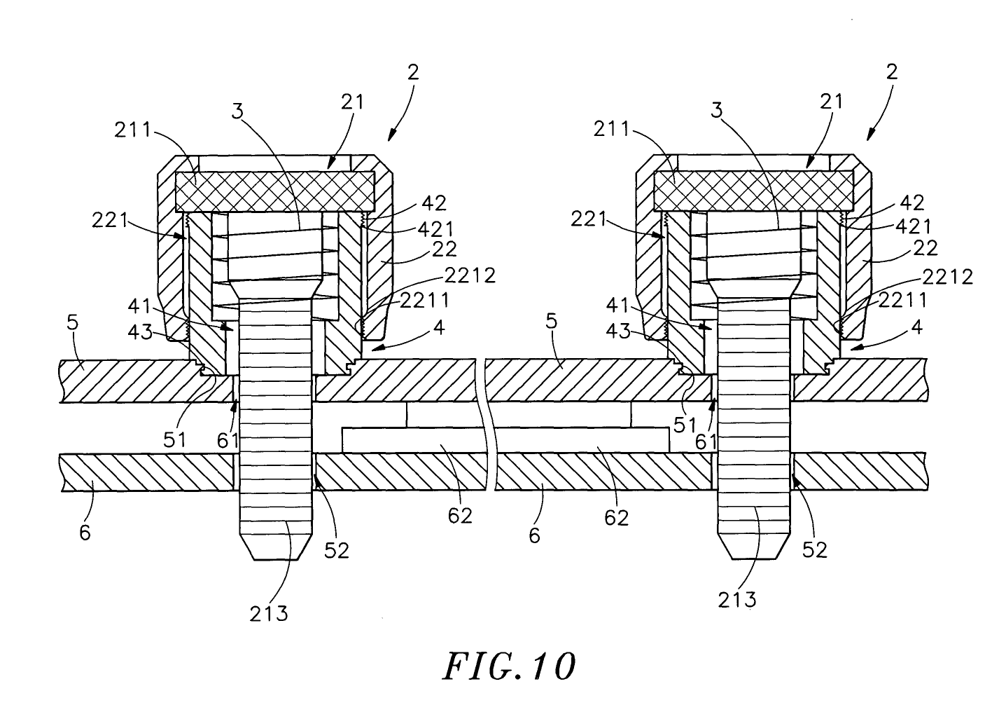

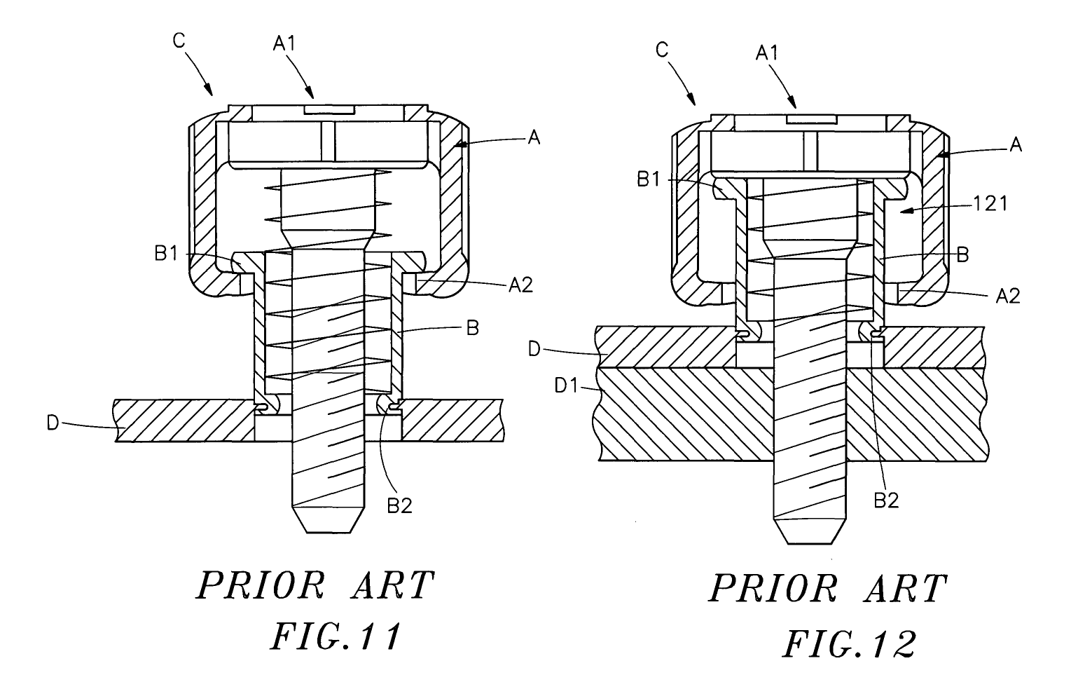

Additionally, referring to FIG. 10, the sectional side view of the fixing member according to another embodiment of the present invention. As described above, the fixing member 1 of the present invention may be used for positioning or securing the first and the second plates 5 and 6, wherein the second plate 6 has a protruded element 62, the first plate 5, and the second plate 6 can be clamped or attached tightly at the upper or lower surface of the protruded element 62, then the securing set 4 and the screw element 2 of the fixing member 1 are fastened to the first plate 5 and the second plate 6. The protruded element 62 may be the general gapping pillar, the CPU on the circuit board or other related elements.

While the invention has been described in conjunction with a specific best mode, it is to be understood that many alternatives, modifications, and variations will be apparent to those skilled in the art in light of the a foregoing description. Accordingly, it is intended to embrace all such alternatives, modifications, and variations, which fall within the spirit and scope of the included claims. All matters set forth herein or shown in the accompanying drawings are to be interpreted in an illustrative and non-limiting sense.

1. A fixing member for securing stacked plates, said fixing member comprising:
a screw element, having a positioning element, wherein said positioning element comprises a socket portion and a shank at a lower portion of said socket portion;
a knob, comprising a receiving space, engagingly surrounding said positioning element, wherein a bottom flange of said knob comprises a internal threaded portion;
a resilient element, positioned in said receiving space of said knob, wherein said resilient element surrounds said shank of said positioning element; and
a securing set, having a through hole and a plurality buckling grooves at a bottom end thereof, wherein at a top flange of said securing set has a corresponding external threaded portion for engaging with said internal threaded portion of said knob, and wherein when said internal threaded portion of said bottom flange of said knob is engaged with said external threaded portion of said top flange of said securing set, the entire screw element is positioned within said through hole of said securing set and said knob.

2. The fixing member according to claim 1, wherein said knob of said screw element comprises a grip portion on the outer flange thereof.

3. The fixing member according to claim 1, wherein said positioning element of said screw element has a top lid inlayed fixing on the inner sidewall of said receiving space of said knob.

4. The fixing member according to claim 1, wherein said knob of said screw element has a supporting portion formed at the upper side of said internal threaded portion in said receiving space.

5. The fixing member according to claim 1, wherein said external threaded portion of said securing set has a supporting portion formed at a lower part thereof.

6. The fixing member according to claim 1, wherein after said internal threaded portion of said screw element is engaged into said external threaded portion of said securing set, said shank of said screw element penetrates through said through hole of said securing set.
